(19) United States
(12) Patent Application Publication
(10) Pub. No.: US 2016/0323100 A1
(43) Pub. Date: Nov. 3, 2016

(54) KEY GENERATION DEVICE, TERMINAL DEVICE, AND DATA SIGNATURE AND ENCRYPTION METHOD

(71) Applicant: HON HAI PRECISION INDUSTRY CO., LTD., New Taipei (TW)

(72) Inventors: TUNG-TSO TSAI, New Taipei (TW); JUNG-YI LIN, New Taipei (TW); CHIH-YUAN CHUANG, New Taipei (TW); CHIH-TE LU, New Taipei (TW); PO-JEN HSU, New Taipei (TW); SHU-YUAN CHANG, New Taipei (TW)

(21) Appl. No.: 14/814,773

(22) Filed: Jul. 31, 2015

(30) Foreign Application Priority Data
Apr. 30, 2015 (TW) 104113792

(51) Int. Cl. H04L 9/08; H04L 9/32

(52) U.S. Cl. CPC H04L 9/0833; H04L 9/0861; H04L 9/0891; H04L 9/3247

(57) ABSTRACT

A key generation device generates an initial secret key, and a time update key at regular intervals, and transmits the initial secret key and the time update key to a terminal device. The terminal device utilizes the initial secret key, the time update key, and a private key generated by the terminal device itself to form a key group. The key group and a public key generated by the terminal device are used as a key pair to encrypt and decrypt data, give a digital signature, and verify digital signatures. The time update key includes a time period, and after the time period expires the time update key cannot be used by the terminal device to generate the key group. A data signature and encryption method is also provided.

### CROSS-REFERENCE TO RELATED APPLICATIONS

This application claims priority to Taiwanese Patent Application No. 104113792 filed on Apr. 30, 2015 in the Taiwan Intellectual Property Office.

### FIELD

The subject matter herein generally relates to data security, and particularly to a key generation device, a terminal device, and a data signature and encryption method thereof.

### BACKGROUND

A certificateless signcryption system at least includes a key generation center and a number of terminal devices. The key generation center generates initial keys and transmits the initial keys to the terminal devices. After the initial keys are transmitted to the terminal devices, the initial keys cannot be revoked.

### BRIEF DESCRIPTION OF THE DRAWINGS

Implementations of the present technology will now be described, by way of example only, with reference to the attached figures.

FIG. 1 is a block diagram illustrating an embodiment of a communication system including at least one key generation device and a number of terminal devices.

FIG. 2 is a block diagram illustrating an embodiment of the key generation device of FIG. 1.

FIG. 3 is a block diagram illustrating an embodiment of the terminal device of FIG. 1.

FIG. 4 is a flowchart illustrating an embodiment of a data signature and encryption method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. In general, the word “module,” as used herein, refers to logic embodied in hardware or firmware, or to a collection of software instructions, written in a programming language. The software instructions in the modules can be embedded in firmware, such as in an erasable programmable read-only memory (EPROM) device. The modules described herein can be implemented as either software and/or hardware modules and can be stored in any type of computer-readable medium or other storage device. The term “coupled” is defined as connected, whether directly or indirectly through intervening components, and is not necessarily limited to physical connections. The connection can be such that the objects are permanently connected or releasably connected. The term “comprising” means “including, but not necessarily limited to”, it specifically indicates open-ended inclusion or membership in a so-described combination, group, series and the like.

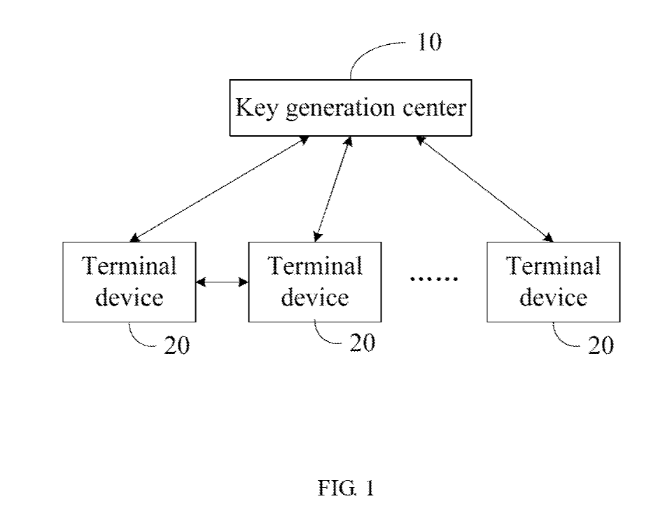

FIG. 1 illustrates an embodiment of a communication system. The communication system includes at least one key generation device 10 and a variety of terminal devices 20. The at least one key generation device 10 can be a server, a computer, a mobile phone, or other devices that having a key generation function and a communication function. The terminal devices 20 can be various portable electronic devices, wearable devices, or other devices having a communication function and a function of data signature and data encryption and decryption. For example the terminal devices 20 can be mobile phones, notebook computers, smart watches, and intelligent glasses.

In at least one embodiment, the key generation device 10 can communicate with the terminal devices 20 wirelessly, for example by using the BLUETOOTH protocol, the ZIGBEE protocol, and the WIFI protocol. In an alternative embodiment, the key generation device 10 can communicate with the terminal devices 20 through wires, for example by using Ethernet or other fixed network protocols.

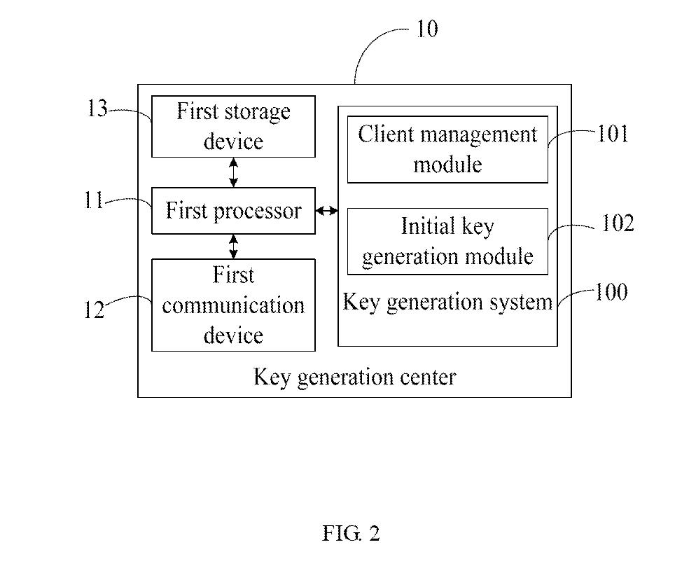

FIG. 2 illustrates an embodiment of the key generation device 10. In at least one embodiment, the key generation device 10 at least includes a first processor 11, a first communication device 12, and a first storage device 13. The first processor 11 can be a central processing unit, a digital signal processor, or a single chip, for example. The first storage device 13 can be an internal storage system, such as a flash memory, a random access memory for temporary storage of information, and/or a read-only memory for permanent storage of information. The first storage device 13 can also be a storage system, such as a hard disk, a storage card, or a data storage medium.

In at least one embodiment, a key generation system 100 is running in the key generation device 10. The key generation system 100 can include a number of modules, which are collection of software instructions stored in the first storage device 13 and executed by the first processor 11. In at least one embodiment, the key generation system 100 at least includes a client management module 101 and an initial key generation module 102.

The client management module 101 registers and releases the terminal devices 20 in response to a user command input via an input device (such as a keyboard or a mouse), or in response to requests sent by the terminal device. In at least one embodiment, each registered terminal device 20 has a unique identifier, the unique identifier can be an IP address or a MAC address of the terminal device 20. The unique identifier can also be an employee number, a telephone number, an email account, or an identification number of a user of the terminal device 20.

When a terminal device 20 is successfully registered to the key generation device 10, the initial key generation module 102 generates an initial secret key according to the unique identifier of the registered terminal device 20, and generates a time update key at regular time intervals. The initial key generation module 102 transmits the initial secret key and the time update key to the registered terminal device 20 via the first communication device 12 after the initial secret key and the time update key is generated.

The time update key at least includes the unique identifier of the terminal device 20 and data as to a time period. The time period can be a fixed length of time, for example thirty days, or a timestamp-delineated period, for example from 06:00 AM of Jan. 1, 2015 to 06:00 AM of Jan. 30, 2015. In at least one embodiment, once the initial key generation module 102 determines that the time period of a time update key is expired, the initial key generation module 102 generates a new time update key and controls the communication device 12 to transmit the new generated time update key to the registered terminal device 20. For example, the time period in a first time update key may be from 06:00 AM of Jan. 1, 2015 to 06:00 AM of Jan. 30, 2015; if the initial key generation module 102 determines that a current time is 06:00 AM of Jan. 30, 2015, the initial key generation module 102 determines that the time period of the first time update key is expired, and then the initial key generation module 102 generates a new time update key, the time period of the new time update key can be from 06:00 AM of Jan. 30, 2015 to 06:00 AM of Feb. 30, 2015.

In at least one embodiment, the initial key generation module 102 generates the time update key at regular time intervals until the initial key generation module 102 receives a command to stop generating the time update key, from the terminal device 20 or from the input device (not shown) of the key generation device 10. The initial key generation module 102 generates the time update key at the regular time intervals until the terminal device 20 logs out and is released from the key generation device 10.

In at least one embodiment, the time period of the time update key can be set by a user via input devices (not shown) of the key generation device 10. In other embodiments, the time period of the time update key also can be automatically set by the initial key generation module 102. In at least one embodiment, any initial secret key and time update key can be generated by using a well known algorithm, such as Hash algorithm.

In at least one embodiment, the first communication device 12 transmits the initial secret key to the terminal device 20 by using an encrypted security channel, and transmits the time update key to the terminal device 20 by using an unencrypted and non-private channel, for example by using a text message, an email, a push notification service, or other unencrypted means. In an alternative embodiment, the time update key further can be posted on a website for the terminal device 20 to download. In other embodiments, the time update key further can be transmitted by using the encrypted security channel.

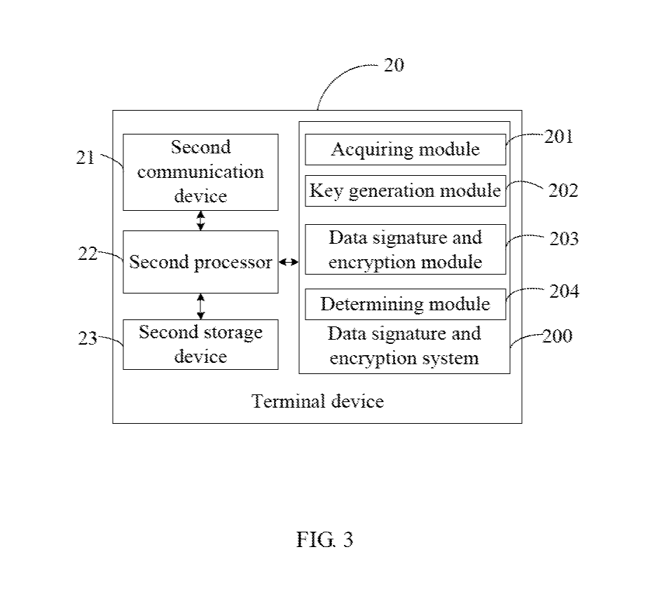

FIG. 3 illustrates a terminal device 20 according to an embodiment. In at least one embodiment, the terminal device 20 includes at least a second communication device 21, a second processor 22, and a second storage device 23. The second communication device 21 communicates with the first communication device 12 of the key generation device 10, and receives the initial secret key and the time update key sent by the key generation device 10. The second processor 22 can be a central processing unit, a digital signal processor, or a single chip, for example. The second storage device 23 can be an internal storage system, such as a flash memory, a random access memory for temporary storage of information, and/or a read-only memory for permanent storage of information. The second storage device 23 can also be a storage system, such as a hard disk, a storage card, or a data storage medium.

A data signature and encryption system 200 is running in each terminal device 20. The data signature and encryption system 200 can include a number of modules, which are collection of software instructions stored in the second storage device 23 and executed by the second processor 22. In at least one embodiment, the data signature and encryption system 200 at least includes an acquiring module 201, a key generation module 202, and a data signature and encryption module 203.

The acquiring module 201 acquires the initial secret key and the time update key from the second communication device 21.

The key generation module 202 generates a public key and a private key according to a preset secret value, and then generates a key group by combining the initial secret key, the time update key and the generated private key.

The data signature and encryption module 203 encrypts and decrypts data, signs digital signatures, and verifies digital signatures by using the public key of the terminal device 20, the key group, and the public key received from other terminal devices.

In detail, the second communication device 21 of each terminal device 20 communicates with other terminal devices 20 to transmit the public key of the terminal device 20 to the other terminal devices 20 and receives public keys of the other terminal devices 20 from the other terminal devices 20. In an alternative embodiment, each terminal device 20 further can upload the public key to the key generation device 20, and the key generation device 20 can broadcast the public key of the terminal device 20 to the other terminal devices 20.

When at least two terminal devices 20 exchange data, a sending terminal device 20 creates a digital signature according to the key group of the sending terminal device 20, and uses the digital signature to sign the date to be transmitted. The sending terminal device 20 further encrypts the data to be transmitted using the public key of a receiving terminal device 20.

When the receiving terminal device 20 receives the encrypted data transmitted by the sending terminal device 20, the receiving terminal device 20 decrypts the data using the key group of the receiving terminal device 20, and verifies the signature using the public key of the sending terminal device 20.

In at least one embodiment, the data signature and encryption system 200 further includes a determining module 204 to determine whether the time period of the time update key is expired. When the key generation device 10 is no longer transmitting the time update key to the terminal device 20, and the determining module 204 determines that the time period of the last time update key is expired, the terminal device 20 cannot generate the key group according to the time update key, thus the terminal device cannot verify the signature and decrypt the data.

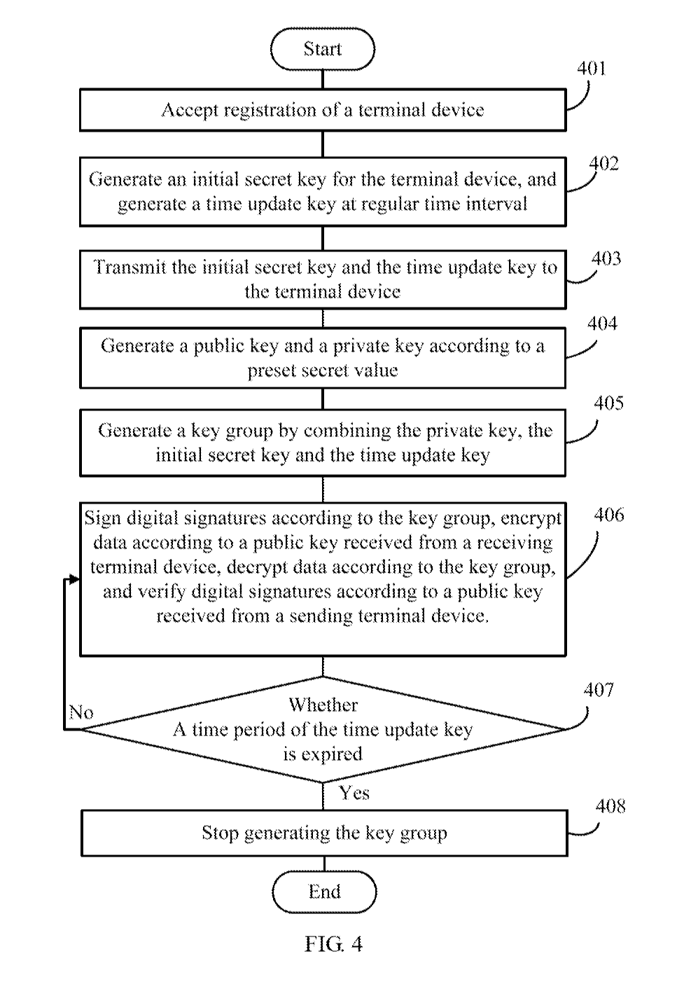

FIG. 4 is a flowchart illustrating an example embodiment of a data signature and encryption method. The method is provided by way of example, as there are a variety of ways to carry out the method. The method described below can be carried out using the configurations illustrated in FIG. 1 to FIG. 3, for example, and various elements of these figures are referenced in explaining the example method. Each block shown in FIG. 4 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 401.

At block 401, a key generation device accepts registration of a terminal device which is identified by a unique identifier.

At block 402, the key generation device generates an initial secret key according to the unique identifier of the terminal device 20, and generates a time update key at regular time intervals. The time update key at least includes the unique identifier of the terminal device and data as to a time period, the length of the regular time interval is equal to the length of the time period.

At block 403, the key generation device transmits the initial secret key and the time update key to the registered terminal device.

At block 404, the terminal device generates a public key and a private key according to a preset secret value.

At block 405, the terminal device generates a key group by combining the private key, the initial secret key, and the time update key.

At block 406, the terminal device encrypts and decrypts data, signs digital signatures, and verifies digital signatures by using the public key of the terminal device, the key group, and public keys received from other terminal devices. In detail, when at least two terminal devices exchange data, the sending terminal device creates a digital signature according to the key group of the sending terminal device, and uses the digital signature to sign the date to be transmitted. The sending terminal device further uses the public key of the receiving terminal device to encrypt the data to be transmitted. When the receiving terminal device receives the data transmitted by the sending terminal device, the receiving terminal device decrypts the data by using the key group of the receiving terminal device, and verifies the signature of the data by using the public key of the sending terminal device.

At block 407, the terminal device determines whether the time period of the time update key is expired, if yes, the procedure goes to block 408; if no, the procedure goes to block 406.

At block 408, the terminal device stops generating the key group.

In at least one embodiment, the method further includes: the time update key is generated at the regular time interval until a command for stop generating the time update key is received or until the terminal device is logout.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A key generation device comprising:
a communication device configured to communicate with at least one terminal device;
a processor coupled to the communication device;
a storage device coupled to the processor and configured to store instructions for execution by the processor to cause the key generation device to:
generate an initial secret key for the at least one terminal device;
generate a time update key at regular time intervals;
control the communication device to transmit the initial secret key and the time update key to the at least one terminal device;
enable the at least one terminal device to utilize the initial secret key, the time update key and a private key generated by the at least one terminal device to form a key group,
wherein the key group and a public key generated by the at least one terminal device are configured to be used as a key pair to encrypt and decrypt data, sign a digital signature for data, and verify digital signature for data; and
wherein each time update key comprises data as to a time period, and after the time period expires, the time update key cannot be used by the at least one terminal device to generate the key group.

2. The key generation device according to claim 1, wherein the key generation device generates the initial secret key and the time update key according to a unique identifier of the terminal device.

3. The key generation device according to claim 1, further comprising a client management module stored in the storage device and comprising at least one instruction configured to cause the processor to register and release the at least one terminal device.

4. The key generation device according to claim 1, wherein the initial key generation module generates the time update key at regular time intervals until the initial key generation module receives a command to stop generating the time update key or until the terminal device logs out and is released from the key generation device.

5. The key generation device according to claim 1, wherein the time update key is transmitted to the at least one terminal device by using an unencrypted and non-private channel.

6. A terminal device comprising:
a communication device to communicate with at least one key generation device to receive an initial secret key and a time update key sent by the key generation device, wherein the time update key is generated by the key generation device at regular time intervals, and the time update key comprises data as to a time period;
a processor coupled to the communication device;
a storage device coupled to the processor and configured to store instructions for execution by the processor to cause the terminal device to:
acquire the initial secret key and the time update key received by the communication device;
generate a public key and a private key according to a preset secret key value;
generate a key group by combining the initial secret key, the time update key and the generated private key, wherein when the time period of the time update key is expired, the time update key cannot be used to generate the key group; and
create a digital signature according to the key group and use the digital signature to sign data to be transmitted, encrypt the data to be transmitted using a public key received from a receiving terminal device, decrypt data received from other terminal devices using the key group, and verify the signature of the data received from the other terminal devices by using the public key of the other terminal devices sending the data.

7. The terminal device according to claim 6, wherein the time update key is transmitted to the at least one terminal device by using an unencrypted and non-private channel.

8. The terminal device according to claim 6, further comprising a determining module stored in the storage device and comprising at least one instruction configured to cause the processor to determine whether the time period of the time update key is expired.

9. The terminal device according to claim 6, wherein the terminal device corresponds to an unique identifier, the key generation device generates the initial secret key and the time update key according to the unique identifier of the terminal device; the unique identifier of the terminal device is one of an IP address, a MAC address of the terminal device, an employee number of a user of the terminal device, a telephone number of the user of the terminal device, an email account of the user of the terminal device, an identification number of the user of the terminal device.

10. A data signature and encryption method operating in a communication system which comprises at least one key generation device and at least one terminal device, the method comprising:
generating an initial secret key, and generating a time update key at regular time intervals by the key generation device, wherein the time update key comprises data as to a time period;
transmitting the initial secret key and the time update key to the at least one terminal device by the key generation device;
generating a public key and a private key according a preset secret key value by the at least one terminal device;
generating a key group by combining the initial secret key, the time update key and the private key by the at least one terminal device; and
creating a digital signature according to the key group and using the digital signature to sign data to be transmitted; encrypting the data to be transmitted using a public key received from a receiving terminal device; decrypting data received from other terminal devices using the key group, and verifying the signature of the data received from the other terminal devices by using the public key of the other terminal devices sending the data.

11. The data signature and encryption method according to claim 10, further comprising:
determining whether the time period of the time update key is expired by the at least one terminal device; and
stopping generating the key group if the time period of the time update key is expired.

12. The data signature and encryption method according to claim 10, wherein the time update key is transmitted to the at least one terminal device by using an unencrypted and non-private channel.

13. The data signature and encryption method according to claim 10, wherein before generating the initial secret key and the time update key, the method further comprises:
accepting a register of the at least one terminal device.

14. The data signature and encryption method according to claim 13, wherein the time update key is generated at the regular time intervals until a command for stop generating the time update key is received or until the terminal device logs out and is released from the terminal device.

15. The data signature and encryption method according to claim 10, wherein the initial secret key and the time update key are generated according to a unique identifier of the at least one terminal device.
